(19) United States
(12) Patent Application Publication
(10) Pub. No.: US 2008/0073478 A1
(43) Pub. Date: Mar. 27, 2008

(54) ATV rod holder

(76) Inventors: George D. Gates, South Jordan, UT (US); Travis D. Gates, Riverton, UT (US)

Correspondence Address: THORPE NORTH & WESTERN, LLP., P.O. Box 1219, SANDY, UT, 84091-1219, US

(21) Appl. No.: 11/528,495

(22) Filed: Sep. 26, 2006

(51) Int. Cl. F16M 13/00

(52) U.S. Cl. 248/523

(57) ABSTRACT

An ATV rod holding device includes a receiving member configured to receive and hold a handle portion of the rod therein. A slot is formed in a wall of the receiving member, the slot being configured to receive and hold a portion of a reel mount of the rod. The slot includes at least a holding chamber sized and shaped to receive without deflecting a portion of a reel mount of the rod therein, and a stress relief portion having a width more narrow than a width of the holding chamber. The stress relief portion extends from the holding chamber and provides stress relief such that the receiving member is not fractured when portions of the receiving member adjacent the slot are splayed.

### BACKGROUND

1. Field of the Invention

The present invention relates generally to article holding devices usable to store articles on vehicles. More particularly, the present invention relates to article holding devices usable to store elongated articles, such as fishing rods, on ATVs and similar vehicles.

2. Related Art

Holding devices that allow consumers to temporarily store items or articles on vehicles have been provided in a variety of configurations. For example, U.S. Pat. No. 4,607,772 discloses a utility carrier that, when paired with another, similar carrier, provides a good system for temporary storage of rifles, garden tools, etc., on the handlebars of vehicles such as motorcycles, all-terrain-vehicles (“ATVs”), etc.

While such systems have been found useful, they have proved problematic in a number of manners. For example, conventional holders of this type are generally configured for the storage of items in a horizontal orientation, e.g., across a plane generally parallel to the terrain over which an ATV is navigated. This orientation can be troublesome when relatively long articles, such as fishing poles, for example, are carried by the ATV. When such articles are carried in this manner, they can extend beyond the handlebars to such a degree that they can become entangled with, or broken by, items adjacent which the ATV is driven (for example, shrubs, brush, fences, etc.). In addition, storage of relatively long articles in a horizontal orientation can interfere with the operation of the ATV on which the articles are stored.

In addition, conventional article holders are generally designed to retain relatively robust items, such as guns, tools, etc., that are not particularly fragile. Attempting to secure a relatively delicate item, such as a fishing pole, to such holders can result in either risking damage to the fishing pole or causing the consumer to go to great lengths to secure the fishing pole to or within the carrier without damaging the fishing pole.

In addition, due to the relatively rough terrain over which ATVs are often driven, it has been found that articles held by such carriers must be securely attached to, or held within, the carriers in order to prevent the articles from becoming dislodged during transit. While it is possible, with some effort, to securely attach items to conventional carriers, most operators of ATVs desire an attachment interface that can be quickly and easily manipulated when both storing and removing articles from the carrier. Thus, some carriers to date have provided attachment systems that are too cumbersome or complex for operators of the ATVs to quickly and easily utilize in order to store and detach items from the carriers.

### SUMMARY OF THE INVENTION

It has been recognized that it would be advantageous to develop a holding device that can be used to safely and securely store items on an ATV in a vertical orientation. In addition, it has been recognized that it would be advantageous to develop a holding device that securely holds fishing rods therein that includes an attachment interface that allows users to quickly and easily attach and detach fishing rods from the holding device.

The invention provides an ATV rod holding device, including a receiving member configured to receive and hold a handle portion of the rod therein. A slot can be formed in a wall of the receiving member, the slot being configured to receive and hold a portion of a reel mount of the rod. The slot can include at least a holding chamber sized and shaped to receive without deflecting a portion of a reel mount of the rod therein, and a stress relief portion having a width more narrow than a width of the holding chamber. The stress relief portion can extend from the holding chamber and can provide stress relief such that the receiving member is not fractured when portions of the receiving member adjacent the slot are splayed.

In accordance with another aspect of the invention, an ATV rod holding device is provided, including a receiving member configured to receive and hold a handle portion of the rod therein and a slot, formed in a wall of the receiving member. The slot can be configured to receive and hold a portion of a reel mount of the rod and can have: an entry channel extending downwardly from an upper portion of the receiving member; a holding chamber extending downwardly from a lower portion of the entry channel; a stress relief channel extending downwardly from the holding chamber; and a stress relief chamber extending downwardly from the holding chamber.

In accordance with another aspect of the invention, a method of making an ATV rod holding device is provided, including: obtaining a receiving member operable to receive and hold a handle portion of the rod therein; forming in the receiving member an entry channel that extends downwardly from an upper portion of the receiving member; forming in the receiving member a holding chamber that extends downwardly from a lower portion of the entry channel; and forming in the receiving member a stress relief portion in communication with the holding chamber, the stress relief portion reducing or eliminating fracture of the receiving member when portions of the receiving member adjacent the entry channel are splayed to receive a portion of a reel mount of the rod therein.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a front view of an ATV rod holding device in accordance with an embodiment of the present invention;

FIG. 2 is a top view of the rod holding device of FIG. 1; and

FIG. 3 is a side, sectioned view of the rod holding device of FIG. 1, taken along section 3-3 of FIG. 1.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention.

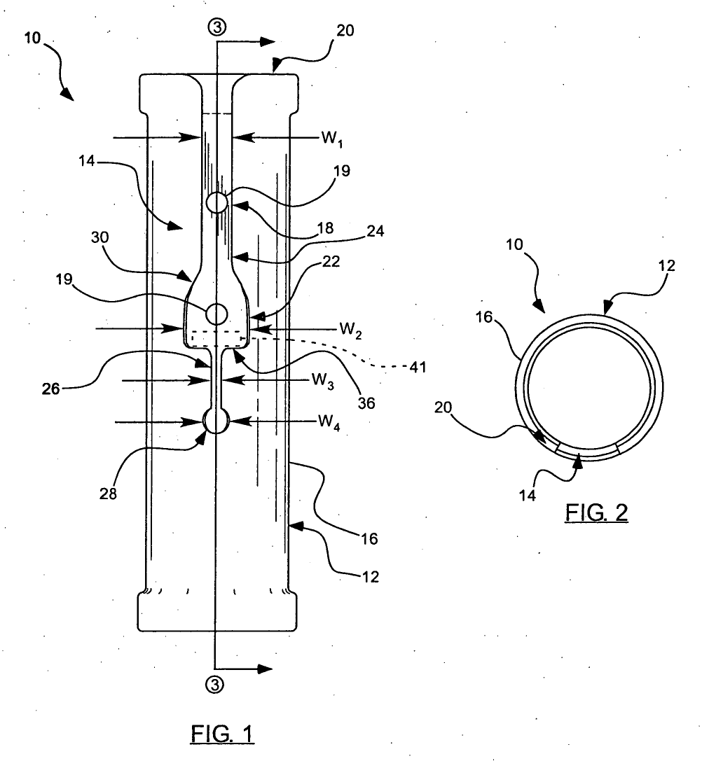

Thus, the following more detailed description of the embodiments of the present invention, as represented in FIGS. 1-3, is not intended to limit the scope of the invention, as claimed, but is presented for purposes of illustration only and to sufficiently enable one skilled in the art to practice the invention. Accordingly, the scope of the present invention is to be defined solely by the claims.

In describing and claiming the present invention, the following terminology will be used.

The singular forms “a,” “an,” and “the” include plural referents unless the context clearly dictates otherwise. Thus, for example, reference to “a rod holder” can include reference to one or more of such rod holders.

As used herein, relative terms, such as “upper,” “lower,” “upwardly,” “downwardly,” etc., are used to refer to various components of rod holders of the present invention, and ATVs generally, as those terms would be readily understood by one of ordinary skill in the relevant art. It is to be understood that such terms in no way limit the present invention but are used to aid in describing the components of the rod holder, and ATVs generally, in the most straightforward manner. When such terms are used in connection with rod holders, it is to be understood that they refer to the generally vertical orientation of the present rod holders when installed on an ATV. In such an orientation, the rod holder is generally vertically aligned such that a rod held within the rod holder will be held in a generally vertical orientation, orthogonal to the plane over which the ATV is being navigated.

As used herein, the term “substantially” refers to the complete or nearly complete extent or degree of an action, characteristic, property, state, structure, item, or result. For example, when an object or group of objects is/are referred to as being “substantially” symmetrical, it is to be understood that the object or objects are either completely symmetrical or are nearly completely symmetrical. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete or near complete lack of an action, characteristic, property, state, structure, item, or result. For example, an opening that is “substantially free of” material would either completely lack material, or so nearly completely lack material that the effect would be the same as if it completely lacked material. In other words, an opening that is “substantially free of” material may still actually contain some such material as long as there is no measurable effect as a result thereof.

### Invention

As shown generally in FIGS. 1-3, the present invention provides an ATV rod holding device 10 that generally includes a receiving member 12 configured to receive and hold a handle portion (shown schematically at 31 in FIG. 3) of the rod therein. A slot 14 can be formed in a wall 16 of the receiving member. The slot can be configured to receive and hold a portion of a reel mount (the portion shown schematically at 41 in FIGS. 1 and 3) of the rod. The slot can include an entry channel 18 extending downwardly from an upper portion 20 of the receiving member. A holding chamber 22 can extend from a lower portion 24 of the entry channel. A stress relief channel 26 can extend from the holding chamber and a stress relief chamber 28 can extend from the stress relief channel.

In use, the holding device 10 can be mounted, in a generally vertical orientation, to a portion of an ATV (not shown), such as the rear cargo rack of the ATV or the handlebars of the ATV. Mounting structure, such as openings 19, can be provided to facilitate attachment of the holding device to the ATV, in manners well known to those of ordinary skill in the art (e.g., U-bolt attachment, bracket assemblies, etc.). A fishing rod, or similarly shaped device, can be stored in the holding device to allow an operator to carry the fishing rod with him-or herself while traveling on the ATV. To store the fishing rod in the holder, the operator can simply insert a lower, handle portion (31 in FIG. 3) of the fishing rod within the holder and force a portion 41 (shown in both FIGS. 1 and 3) of the reel mount utilized to mount the reel (shown schematically at 51 in FIG. 3) to the rod into the holding chamber 22.

Generally, the portion 41 of the reel mount will include a width that is larger than a width W₁ of the entry channel 18 of the slot 14. Thus, some degree of force will generally be required to force the portion 41 of the reel mount into the entry channel, which will result in portions of the wall 16 adjacent the slot to splay outwardly or inwardly to accommodate entry of the portion 41 of the reel mount. The operator would continue to force the portion 41 downwardly through the entry channel until the portion 41 enters the holding chamber 22. The holding chamber generally includes a width W₂ that is wider than a width of the portion 41 such the portion 41 can reside within the holding chamber without splaying the wall or walls of the receiving member.

Once inside the holding chamber 22, the portion 41 of the reel mount is restricted from moving upward relative to the holding device due to the smaller width W₁ of the entry channel. Thus, the operator can operate the ATV with the rod held within the holding device without fear that the rod will become dislodged from the holding device. When it is desired to remove the rod from the holder, the operator can simply apply a consistent, upward force to the rod, causing the portion 41 of the reel mount to again splay the walls of the receiving member and travel upwardly through the entry channel until the portion is clear from the holding device.

In some aspects of the invention, a tapering transition section 30 can be formed between the holding chamber 22 and the entry channel 14 to ease the transition of the portion 41 of the reel mount from the holding chamber to the entry channel. While not so required, the tapered portion can include a substantially continuously curved profile to enable ease of removal of the rod from the holding device.

The present invention thus provides an ATV rod holding device that can be used by an operator of the ATV to safely store a fishing rod on an ATV, in a generally vertical orientation, in a fast and easy manner. It has been found that the present device allows the operator to both quickly insert and remove a rod from the holder, yet the holder safely retains the rod during operation of the ATV.

In the embodiments illustrated in the figures, the entry channel 18 can include a width W₁ on the order of about 0.375 inches, the holding chamber 22 can include a width W₂ on the order of about 0.75 inches, the stress relief channel 26 can include a width W₃ on the order of about 0.125 inches, and the stress relief chamber 28 can include a width (or diameter) W₄ on the order of about 0.25 inches. Also, it will be appreciated from the figures that the holding chamber can include a width W₂ that is larger than the width W₁ of the entry channel, the entry channel can include a width W₁ that is larger than the width W₃ of the stress relief channel, and the stress relief channel can include a width W₃ that is smaller than the widths W₁ and W₄ of both the entry channel and the stress relief chamber, respectively.

The receiving member 12 of the holding device 10 can be formed from a variety of materials but will generally be formed from a material that is relatively rigid, yet pliable enough to deflect to some degree to allow insertion of the portion 41 of the reel mount within the entry channel 18. In one aspect of the invention, the receiving member is formed from a section of a nylon tube having an inside diameter of about 1.25 inches and a wall thickness of about 0.125 inches.

While portions of the wall 16 of the receiving member 12 are allowed to splay as the portion 41 of the reel seat is inserted through the entry channel 18 and into the holding chamber 22, permanent damage to the receiving member is reduced or limited by the presence of the stress relief channel 26 and/or the stress relief chamber 28. These stress relief sections allow the walls adjacent the entry channel to flex without creating a large stress concentration at the base of the receiving chamber or slot 14. In normal conditions, the development of such a large stress concentration might otherwise result in the wall 16 of the receiving member cracking, breaking or otherwise becoming damaged due to the flexure of the wall adjacent the slot. The stress relief features of the present invention allow a great number of cycles of insertions and removals of the fishing rod into/from the holding device without incurring permanent damage.

While not so required, the stress relief chamber 28, which is, in some embodiments, the terminal portion of the slot 14 (e.g., the bottommost portion of the slot), can be formed with a generally continuously curved profile. In this manner, stress concentrations within the stress relief chamber can be minimized to limit or prevent permanent damage to the receiving member during flexing or splaying of the wall or walls of the receiving member. While the stress relief channel 26 and the stress relief chamber are shown in the figures as being disposed beneath the holding chamber 22 and the entry channel 18, it is to be understood that the invention is not so limited. For example, in other embodiments, the stress relief features (e.g., stress relief channel and chamber) can extend laterally from the holding chamber at a variety of angles relative to vertical.

As best appreciated from FIG. 1, in one aspect of the invention, the holding chamber 22 can include support structure 36 that is sufficiently rigid to retain the portion 41 of the reel mount within the holding chamber while an ATV on which the holding device is coupled is operated. In the embodiment shown, the support structure includes a generally shelf-like configuration on which the portion 41 can rest while the portion is held within the chamber. The shelf-like configuration can be oriented in a generally horizontal position (e.g., generally orthogonal to the vertical direction in which the fishing rod is held). The support structure can take a variety of forms but generally provides a resting surface for the portion 41 that inhibits or limits entry of the portion 41 into the underlying stress relief channel 26 or stress relief chamber 28. In this manner, the stress relief features of the present invention can provide stress relief without being inhibited by the presence of portion 41 of the reel mount in either stress relief feature.

While not so limited, in one aspect of the invention the various features of the slot 14 (e.g., the entry channel 18, the holding chamber 22, the stress relief channel 26, and the stress relief chamber 28) can be formed symmetrically about a longitudinal axis of the slot. In this manner, the features of the invention are best able to provide consistent, reliable operation through many cycles of use.

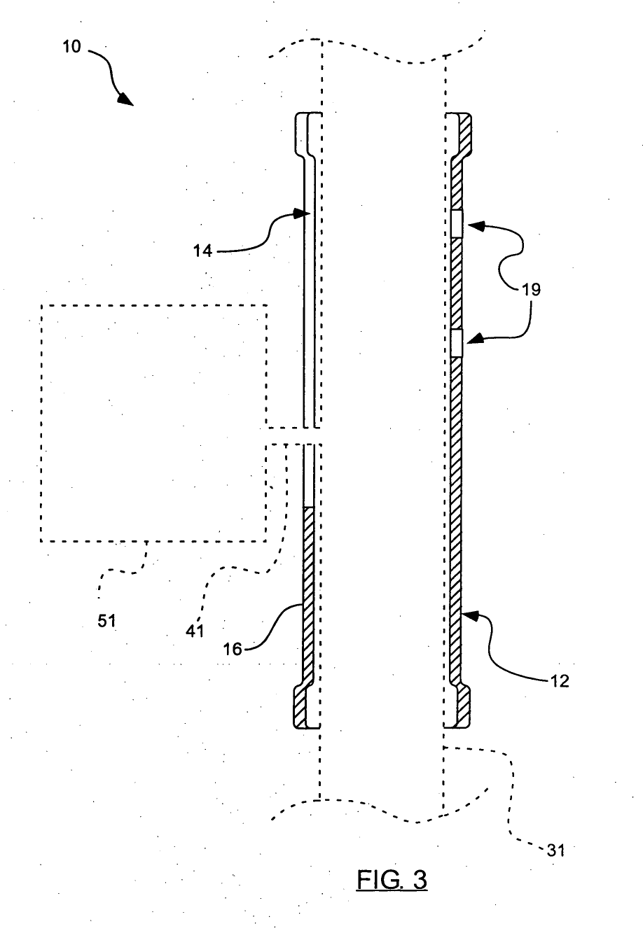

As illustrated in FIG. 2, the receiving member 12 can include a generally circular cross section, similar to a section of conventional piping material. However, the receiving member can also be formed in a shape other than circular, including oval shapes, square, rectangular, etc., as may best be suited for a particular application. The overall dimensions of the receiving member can also vary. In the embodiment of the invention illustrated in the figures, the receiving member includes an external diameter on the order of about 1.5 inches and a length (or height) on the order of about 6 inches.

In addition to the structure discussed above, the present invention also provides a method of making an ATV rod holding device, comprising: obtaining a receiving member operable to receive and hold a handle portion of the rod therein; forming in the receiving member an entry channel that extends downwardly from an upper portion of the receiving member; forming in the receiving member a holding chamber that extends downwardly from a lower portion of the entry channel; and forming in the receiving member a stress relief portion in communication with the holding chamber, the stress relief portion reducing or eliminating fracture of the receiving member when portions of the receiving member adjacent the entry channel are splayed to receive a portion of a reel mount of the rod therein.

The method can further include forming a tapering transition section between the holding chamber and the entry channel, the tapering transition section being configured to facilitate easy removal of the rod from the holding device.

The method can further include leaving a substantially uninterrupted wall beneath the stress relief portion.

The method can further include forming the slot such that the holding chamber includes a largest width, the entry channel includes a width narrower than the holding chamber, and the stress relief portion includes a width narrower than the entry channel.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. An ATV rod holding device, comprising:
a receiving member configured to receive and hold a handle portion of the rod therein;
a slot, formed in a wall of the receiving member, the slot being configured to receive and hold a portion of a reel mount of the rod and including at least:
a holding chamber sized and shaped to receive without deflecting a portion of a reel mount of the rod therein; and
a stress relief portion having a width more narrow than a width of the holding chamber, the stress relief portion extending from the holding chamber and providing stress relief such that the receiving member is not fractured when portions of the receiving member adjacent the slot are splayed.

2. The holding device of claim 1, further comprising an entry channel, formed in the receiving member adjacent the holding chamber, the entry channel being configured to allow insertion of the portion of the reel mount of the rod into the slot and within the holding chamber.

3. The holding device of claim 2, further comprising a tapering transition section formed between the holding chamber and the entry channel, the tapering transition section being configured to facilitate easy removal of the rod from the holding device.

4. The holding device of claim 1, wherein the stress relief portion comprises a stress relief channel, and further comprising a stress relief chamber in communication with the stress relief channel.

5. The holding device of claim 4, wherein the receiving member includes a substantially uninterrupted wall beneath the stress relief portion.

6. The holding device of claim 2, wherein the holding chamber includes a largest width, the entry channel includes a width narrower than the holding chamber, and the stress relief portion includes a width narrower than the entry channel.

7. The holding device of claim 1, wherein the holding chamber includes support structure sufficiently rigid to retain the portion of the reel mount within the holding chamber while an ATV on which the holding device is coupled is operated.

8. The holding device of claim 1, wherein the holding chamber and the stress relief portion are symmetric about a longitudinal axis of the slot.

9. An ATV rod holding device, comprising:
a receiving member configured to receive and hold a handle portion of the rod therein;
a slot, formed in a wall of the receiving member, the slot configured to receive and hold a portion of a reel mount of the rod and having:
an entry channel extending downwardly from an upper portion of the receiving member;
a holding chamber extending downwardly from a lower portion of the entry channel;
a stress relief channel extending downwardly from the holding chamber; and
a stress relief chamber extending downwardly from the stress relief channel.

10. The holding device of claim 9, further comprising a tapering transition section formed between the holding chamber and the entry channel, the tapering transition section being configured to facilitate easy removal of the rod from the holding device.

11. The holding device of claim 9, wherein the receiving member includes a substantially uninterrupted wall beneath the stress relief portion.

12. The holding device of claim 9, wherein the holding chamber includes a largest width, the entry channel includes a width narrower than the holding chamber, and the stress relief portion includes a width narrower than the entry channel.

13. The holding device of claim 9, wherein the holding chamber includes support structure sufficiently rigid to retain the portion of the reel mount within the holding chamber while an ATV on which the holding device is coupled is operated.

14. The holding device of claim 13, wherein the support structure includes a shelf substantially orthogonal to a longitudinal axis of the holder.

15. The holding device of claim 9, wherein the holding chamber, the entry channel, the stress relief channel and the stress relief chamber are symmetric about a longitudinal axis of the slot.

16. The holding device of claim 9, wherein the stress relief chamber includes a substantially continuously curved profile.

17. A method of making an ATV rod holding device, comprising:
obtaining a receiving member operable to receive and hold a handle portion of the rod therein;
forming in the receiving member an entry channel that extends downwardly from an upper portion of the receiving member;
forming in the receiving member a holding chamber that extends downwardly from a lower portion of the entry channel; and
forming in the receiving member a stress relief portion in communication with the holding chamber, the stress relief portion reducing or eliminating fracture of the receiving member when portions of the receiving member adjacent the entry channel are splayed to receive a portion of a reel mount of the rod therein.

18. The method of claim 17, further comprising forming a tapering transition section between the holding chamber and the entry channel, the tapering transition section being configured to facilitate easy removal of the rod from the holding device.

19. The method of claim 17, wherein the receiving member includes a substantially uninterrupted wall beneath the stress relief portion.

20. The method of claim 17, wherein the holding chamber includes a largest width, the entry channel includes a width narrower than the holding chamber, and the stress relief portion includes a width narrower than the entry channel.
